(19) United States
(12) Patent Application Publication
(10) Pub. No.: US 2023/0191650 A1
(43) Pub. Date: Jun. 22, 2023

(54) METHOD FOR PRODUCING A DECORATIVE MOLDED PART

(71) Applicant: JOYSONQUIN Automotive Systems GmbH, Rutesheim (DE)

(72) Inventor: Philip FRUCHT, Renningen (DE)

(21) Appl. No.: 18/079,206

(22) Filed: Dec. 12, 2022

(30) Foreign Application Priority Data
Dec. 16, 2021 (DE) 102021133466.7

(51) Int. Cl. B27K 5/02; B05D 5/06

(52) U.S. Cl. CPC B27K 5/02; B05D 5/061; B05D 2203/20

(57) ABSTRACT

Method for producing a decorative molded part, in which a veneer is joined to a substrate on its rear side opposite a visible surface of the veneer, and in which the visible surface of the veneer is bleached differently to produce a bleaching pattern.

### FIELD OF THE INVENTION

The present invention relates to a method for producing a decorative molded part.

### BACKGROUND OF THE INVENTION

In this method, as in the method known for example from DE 43 01 444 A1, a substrate is provided on a rear side opposite a visible side of a veneer, which substrate is joined to the veneer.

### SUMMARY OF THE INVENTION

In the method according to the invention, the substrate is usually an injection-molded substrate which is joined to the veneer by inserting the veneer, where appropriate after preceding lamination and preceding three-dimensional shaping, at its rear side into an injection mold and joining it to the substrate at the rear side by injecting the plastic material forming the substrate into the injection mold in molten form and solidifying it against the rear side of the veneer.

In the method according to the invention, the visible side of the veneer can then be provided with a transparent or translucent cover layer in a manner known. In this case, the veneer is protected from environmental influences by the cover layer, but is visible through the cover layer so that the visual and aesthetic appearance of the decorative molded part is determined or co-determined by the veneer layer.

However, such a cover layer can also be dispensed with in the proper procedure. In this case, the visible side of the veneer forms the outer surface of the decorative molded part.

The present invention is based on the problem to provide a method for producing a decorative molded part which allows a greater variation of the design statement when using a veneer.

In order to solve this problem, the present invention proposes a method with the features of a bleaching pattern. In this method, at least the visible surface of the veneer is bleached differently to produce a bleaching pattern.

As is generally the case, in the method according to the invention, bleaching is also carried out with the aim of removing all or part of the natural wood colorants from the veneer so that the veneer appears with a different color spectrum or the coloring of the veneer produces a clearer effect, since a veneer completely or partially freed of the natural wood color brings out the color shade used in coloring with greater radiance. It is also possible to use bleaching to better bring out the contrast of the veneer's natural grain.

In the prior art, bleaching is performed uniformly to achieve post-treatment steps such as coloring and/or varnishing on a uniform surface of the veneer that appears harmonious overall.

With the present invention, at least the visible side surface of the veneer is bleached differently to produce a bleaching pattern. Thus, as part of the bleaching process, a bleaching pattern is produced on the visible side surface of the veneer. This bleaching pattern is intended to create or help convey an aesthetic effect. The bleaching pattern can influence the subsequent entry or application of color. Like the bleaching pattern, the applied color will also be visible with varying intensity or radiance. After bleaching, the visible side surface can also merely be painted transparent clear or coated. In this case, the bleached wood surface defines the aesthetic appearance of the decorative molded part.

In the method according to the invention, at least one bleaching medium is deliberately applied to surface segments of at least the visible side surface of the veneer for different lengths of time. This is done with the aim of producing a specific, deliberately selected bleaching pattern at least on the visible side of the veneer, which is the design of the decorative molded part to be produced.

Further embodiments of the present invention propose different possibilities for applying the bleaching medium to surface segments of at least the visible side surface of the veneer for different lengths of time. Thus, it is possible to perform several bleaching cycles, during which the bleaching medium is allowed to act on the veneer. In this process, the bleaching medium can evenly wet the surface in each cycle, wherein the surface of the veneer can be treated between individual cycles in order to protect at least a specific surface segment from the action of the bleaching medium, or bleaching medium can be brought to action in concentrated form at specific locations. This can be done, for example, by masking surface segments. Masking can be done by a protective application or a masking cut. Masking can be done before the first or single bleaching of the veneer. Masking can also be done between different cycles for bleaching the veneer.

A particularly simple and effective way of achieving different bleaching is to immerse surface segments of the visible side surface of the veneer in a bleaching medium for different lengths of time. This effect is usually produced by adapted relative movements between the veneer and the bleaching medium usually provided as a bath. For example, the veneer can thus be immersed step by step in a bleaching medium. The stepwise immersion of the veneer in the bleaching medium is usually carried out with the aim of forming discrete bleaching gradations within the bleaching pattern. These bleaching gradations can characterize or at least help to characterize the bleaching pattern.

Alternatively or additionally, the veneer can be continuously immersed in the bleaching medium. The continuous immersion of the veneer in the bleaching medium is carried out with the aim of producing a continuously varying bleaching pattern. Of course, the two measures described above can also be combined with each other in order to first produce a bleaching pattern with bleaching gradations and then to supplement or attenuate these bleaching gradations by continuous transitions.

In one variant, which can also be carried out in combination with stepwise and/or continuous immersion of the veneer, the veneer is immersed several times in a bleaching medium. Between the respective immersions, the veneer undergoes a change in position so that the veneer is immersed in the bleaching medium with a different alignment than in a preceding immersion process. Individual immersion processes can be carried out in such a way that the veneer or the visible side surface thereof is only partially immersed in the bleaching medium, while another surface section remains outside the bleaching medium and is not subsequently bleached.

The veneer is bleached with a suitable bleaching agent, e.g. a medium containing peroxide.

The bleaching medium is allowed to act for at least a few minutes during each bleaching cycle or on the surface segment to be bleached, usually for about five to 20 minutes. Depending on the bleaching medium and the type of wood, complete bleaching can usually be achieved after 6 to 8 hours of exposure time. This exposure time, or a significant portion of it, can be divided into evenly spaced intervals, each of which subjects another surface section to bleaching. In this way, a uniformly graded bleaching pattern can be produced on the veneer.

After bleaching, the thus pre-treated veneer can be formed three-dimensionally in the subsequent trim part process, if appropriate after preceding lamination on the rear side of the veneer. The three-dimensional preform formed in this way can be back injection molded in an injection mold to form the rear side of the substrate and subsequently colored on the visible side. Alternatively or additionally, the visible side can be coated or painted with a transparent or translucent cover layer, which may also be colored, preferably by injection molding. With this colored post-treatment within the veneer and/or on the veneer, the design formed by the bleached pattern is still retained so that the bleached pattern may appear as a colored pattern and/or a pattern covered with color on the visible side of the decorative molded part.

Further details and advantages of the present invention will be apparent from the following description of embodiments in conjunction with the drawing.

### BRIEF DESCRIPTION OF THE DRAWINGS

Therein:

FIG. 1 shows a schematic longitudinal sectional view of an embodiment of a decorative molded part;

FIG. 2 shows a first embodiment of a bleaching pattern;

FIG. 3 a second embodiment of a bleaching pattern;

FIG. 4 a third embodiment of a bleaching pattern and

FIGS. 5a to c show schematic cycles for producing another embodiment of a bleach pattern.

### DETAILED DESCRIPTION OF THE PREFERRED EMBODIMENTS

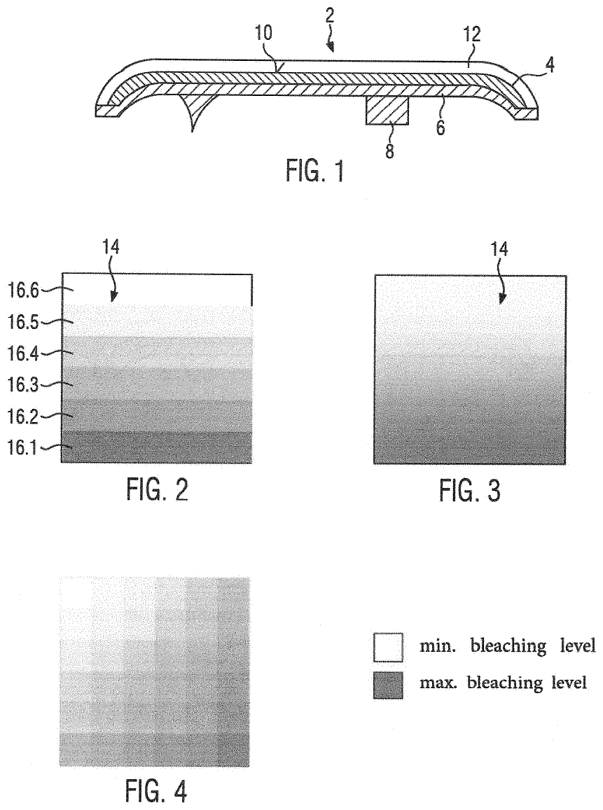

FIG. 1 schematically shows a decorative molded part, characterized by reference sign 2, which has a veneer 4 as the decorative layer, which is provided with a lamination on the rear side and is connected to a substrate 6 with this lamination interposed. The substrate 6 has attachment elements, for example in the form of pins 8, which serve to mount and hold the decorative molded part 2 in the interior of a motor vehicle.

On the visible side of the veneer 4, characterized by reference sign 10, there is a cover layer 12 in the embodiment according to FIG. 1, which is formed from a transparent plastic by overmolding the veneer 4 opposite the substrate 6.

Various variants for forming a bleaching pattern characterized by reference sign 14 are illustrated below with reference to FIGS. 2 to 5.

The bleaching pattern 14 shown in FIG. 2 has strips 16. The different strips 16.1 to 16.6 correspond to the different levels of bleaching. The darkest, lowest strip 16.1 illustrates the maximum level of bleaching. The uppermost, lightest strip 16.6 indicates the minimum level of bleaching. A maximum level of bleaching can be achieved by maximum long or maximum intensive bleaching. It is assumed here that the bleaching medium has the same bleaching efficiency in each cycle of the bleaching process.

The bleaching pattern 14 shown in FIG. 2 is achieved by first immersing the veneer 4 corresponding to the lower strip 16.1 in the bleaching medium. After a first reaction time, the veneer is immersed in the bleaching medium by a further stage corresponding to the height of the second strip 16.2. After the same exposure time as in the first step, a further step is carried out so that the veneer 4 is now immersed in the bleaching medium according to the height of the strips 16.1 to 16.3. Further steps follow until, in the last step, the last strip 16.6 is also immersed in the bleaching medium. In the embodiments shown, the exposure time is identical in each individual step. This results in uniformly graduated strips 16.1 to 16.6 which form the bleaching pattern 14.

The embodiment shown in FIG. 3 is produced in a similar way to the embodiment shown in FIG. 2. Instead of a stepwise immersion of the veneer 4 in the bleaching medium, this is done continuously.

Thus, FIG. 3 shows continuous transitions of the bleaching levels. These are provided with the same maximum and minimum intensity as strips 16.1 and 16.6, respectively.

FIG. 4 shows a bleaching pattern 14 produced by rotating the position of the veneer 4 by 90 degrees at least between a first and a second sequence. The bleaching pattern 14 shown in FIG. 4 is initially based on the bleaching pattern shown in FIG. 2. After this bleaching pattern has been generated, the veneer 4 is rotated through 90 degrees and then again immersed stepwise in the bleaching medium as described with reference to FIG. 2. However, the times between the individual bleaching steps can be kept shorter before and after turning so that a maximum bleaching level is obtained in the lower right corner for a lowest square 18 corresponding to the bleaching level of the lowest strip 16.1. In the embodiment according to FIG. 4, the steps are selected identically in each case. This results in squares.

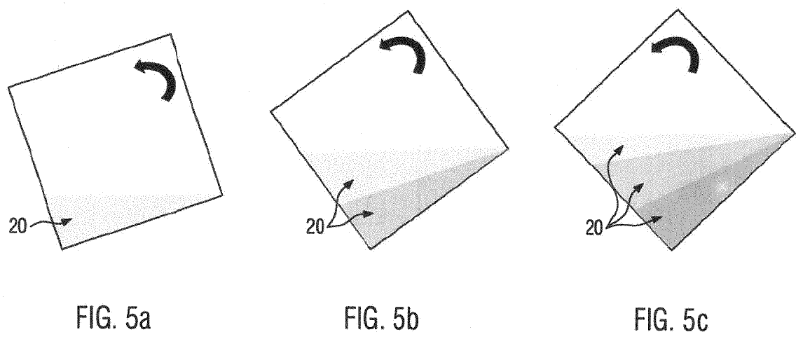

In the embodiment according to FIGS. 5a to c, the veneer 4 is initially immersed in the bleaching medium at a slight angle in a first bleaching cycle according to FIG. 5a. As a result, a lower triangle comprising two edge lengths of the veneer 4 is bleached. The veneer 4 is then kept immersed and rotated counterclockwise. However, the veneer 4 is immersed in such a way that the right corner of the square veneer 4 coincides with the level of the bleaching medium. The position of this corner is not changed during further immersion. This results in a second triangular design. By pivoting again, the veneer 4 is immersed deeper in the bleaching medium as shown in FIG. 5c. Three triangles 20 with different bleaching intensities appear on the visible side 10.

As before, further surface segments of veneer 4 can be created by pivoting and lowering the veneer 4 into the bleaching medium so that between the individual triangles 20 a gradation of bleaching levels is effected as shown in FIG. 2.

### LIST OF REFERENCE SIGNS

2 decorative molded part

4 veneer

6 substrate

8 pin

10 visible side

12 cover layer

14 bleaching pattern

16 strip

18 square

20 triangle

What is claimed is:

1. Method for producing a decorative molded part, in which a veneer is joined to a substrate on a rear side of the veneer opposite a visible surface of the veneer, wherein the visible surface of the veneer is bleached differently to produce a bleaching pattern.

2. Method according to claim 1, wherein a bleaching medium acts on surface segments of the visible surface of the veneer for different lengths of time.

3. Method according to claim 1, wherein surface segments of the visible surface of the veneer are masked during the process of bleaching.

4. Method according to claim 1, wherein a surface segment of the visible surface of the veneer is immersed in a bleaching medium for different lengths of time.

5. Method according to claim 1, wherein immersion of the veneer in a bleaching medium is carried out stepwise.

6. Method according to claim 1, wherein immersion of the veneer in a bleaching medium is continuous.

7. Method according to claim 1, wherein the veneer is immersed several times in a bleaching medium and that the veneer undergoes a change of position between each immersion, so that the veneer is immersed in the bleaching medium with a different alignment than in a preceding immersion process.

8. Method according to claim 1, wherein immersion of the veneer in a bleaching medium is carried out stepwise and that the veneer is immersed several times in a bleaching medium and that the veneer undergoes a change of position between each immersion, so that the veneer is immersed in the bleaching medium with a different alignment than in a preceding immersion process.

9. Method according to claim 1, wherein immersion of the veneer in a bleaching medium is continuous and that the veneer is immersed several times in a bleaching medium and that the veneer undergoes a change of position between each immersion, so that the veneer is immersed in the bleaching medium with a different alignment than in a preceding immersion process.

10. Method for producing a decorative molded part, comprising the steps of:
bleaching a visible surface of a veneer forming a bleaching pattern on the visible surface of the veneer; and
joining the veneer to a substrate, the veneer having a rear side opposite the visible surface with the rear side joined to the substrate.

11. Method for producing a decorative molded part according to claim 10 wherein:
the bleaching pattern comprises different bleaching intensities.

12. Method for producing a decorative molded part according to claim 11 wherein:
the bleaching pattern comprises graduated strips.

13. Method for producing a decorative molded part according to claim 11 wherein:
the bleaching pattern comprises a continuous transition.

14. Method for producing a decorative molded part according to claim 10 wherein:
said step of bleaching comprises immersing portions of the veneer in a bleaching medium for different exposure times.

15. Method for producing a decorative molded part according to claim 10 further comprising the step of:
masking specific locations of the visible surface of the veneer.
